(19) United States
(12) Patent Application Publication
(10) Pub. No.: US 2012/0029748 A1
(43) Pub. Date: Feb. 2, 2012

(54) Hybrid Electrical Vehicle Powertrain with an Enhanced All-Electric Drive Mode System and Method of Control

(75) Inventors: Shailesh Shrikant Kozarekar, Novi, MI (US); Gregory Dean Gardner, Livonia, MI (US)

(73) Assignee: FORD GLOBAL TECHNOLOGIES, LLC, Dearborn, MI (US)

(21) Appl. No.: 13/198,740

(22) Filed: Aug. 5, 2011

(51) Int. Cl. B60W 20/00; B60W 10/08

(52) U.S. Cl. 701/22; 477/3; 180/65.265; 903/930; 180/65.285

(57) ABSTRACT

A system and method of controlling a hybrid electric vehicle powertrain is provided. The hybrid-electric powertrain includes an engine, a battery, an electric motor, an electric generator and a transmission with a planetary gear unit. The planetary gear unit mechanically couples the engine, the electric motor and the electric generator to effect power delivery to vehicle traction wheels. Stored electrical power is delivering to the electric motor to drive the traction wheels in an electric-only operation mode. A first amount of torque is applied to the planetary gear unit with the electric generator in order to reduce the amount of wear to the planetary gear unit in the electric-only operation mode.

### TECHNICAL FIELD

The invention relates to a hybrid electric vehicle powertrain having transmission gearing with gearing elements for establishing separate power flow paths from two power sources to vehicle fraction wheels

### BACKGROUND

A known hybrid electric vehicle powertrain with dual power flow paths between an engine and vehicle traction wheels and between an electric motor and vehicle traction wheels will permit the vehicle to operate with maximum performance by managing power distribution from each power source. This includes managing the operating state of the engine, the electric motor, a generator and a battery.

The battery, the generator and the motor are electrically coupled. A vehicle system controller is interfaced with a transmission control module to ensure that power management for optimum performance and drivability is maintained.

The powertrain may comprise gearing that defines a parallel power flow configuration in which motor torque and engine torque are coordinated to meet a wheel torque command. The vehicle system controller may cause the engine to be shut down under certain operating conditions, such as during a steady-state highway cruising mode for the vehicle, so that the vehicle may be powered solely by the electric motor. At this time, the battery acts as a power source for the motor. If the battery state-of-charge becomes reduced below a calibrated threshold value during the all-electric drive mode, the engine may be started to charge the battery and to provide a mechanical power source to complement the electric motor torque.

An example of a hybrid electric vehicle powertrain of this type may include a planetary gear set that is used to direct engine power to either an electric power flow path or a mechanical power flow path. Such a powertrain is disclosed, for example, in U.S. Pat. No. 7,268,442 is assigned to the assignee of this invention. That powertrain includes a planetary gear set wherein the sun gear of the planetary gear set is drivably connected to the generator, the engine is drivably connected to the carrier of the planetary gear set and the motor is drivably connected to the ring gear of the planetary gear set. The power flow path is split by the planetary gear set when both the engine and the motor are active.

If the hybrid electric vehicle powertrain is a so-called “plug-in” powertrain, the motor will be operated for a significant period of a total driving event while the engine is off. A battery charge depletion strategy then is used to supply electrical energy to the motor until a battery state-of-charge depletion threshold is reached. The battery, following charge depletion, then may be charged by a public utility electric power grid in preparation for a subsequent driving event.

### BRIEF DESCRIPTION OF THE DRAWINGS

FIG. 1 is a schematic diagram of a hybrid electric vehicle powertrain with divided power flow paths;

FIG. 2 is a schematic diagram of the planetary gear set of FIG. 1;

FIG. 3 is a lever analogy diagram that will be used to describe the function of the planetary gear set when the engine on;

FIG. 4 is a lever analogy diagram for the planetary gear set when the engine is off; and

FIG. 5 is a flowchart illustrating the control strategy of the hybrid electric vehicle powertrain of FIG. 1.

### DETAILED DESCRIPTION

As required, detailed embodiments of the present invention are disclosed herein; however, it is to be understood that the disclosed embodiments are merely examples of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

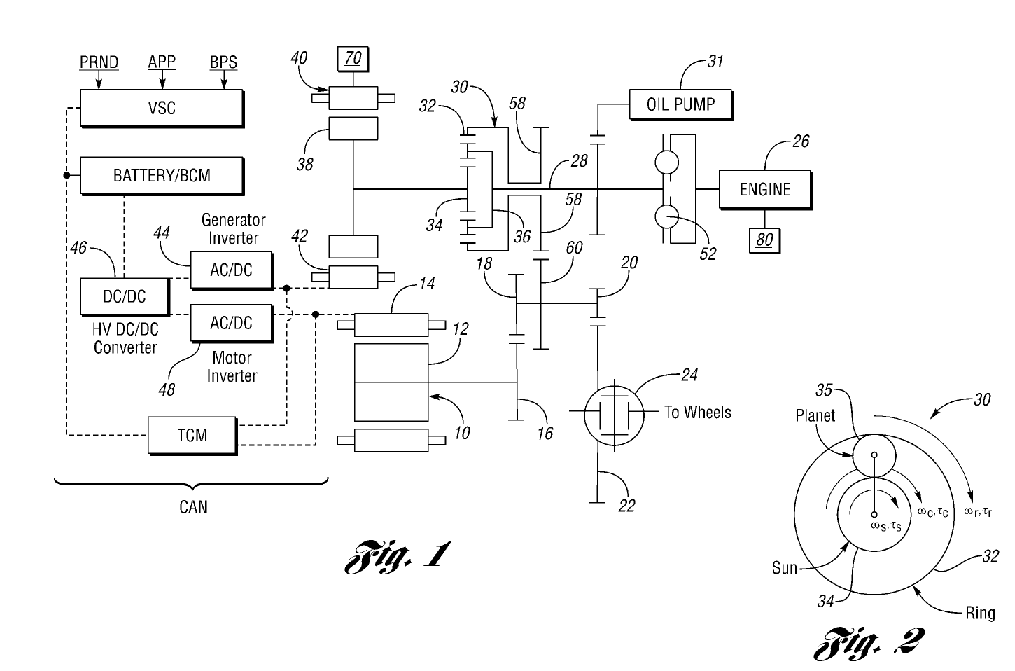

A schematic representation of the architecture for a hybrid electric vehicle powertrain is shown in FIG. 1. It includes an electric motor 10 with a rotor 12 and a stator 14. Rotor 12 is drivably connected to gear 16, which meshes with countershaft gear 18. A companion countershaft gear 20 engages drivably gear 22 of a differential-and-axle assembly 24, which in turn drives the vehicle fraction wheels. Engine 26, which may be an internal combustion engine or any other suitable vehicle engine (e.g., spark-ignition or diesel) is connected to power input shaft 28 for a planetary gear unit 30. A transmission oil pump 31 can be geared to the shaft 28.

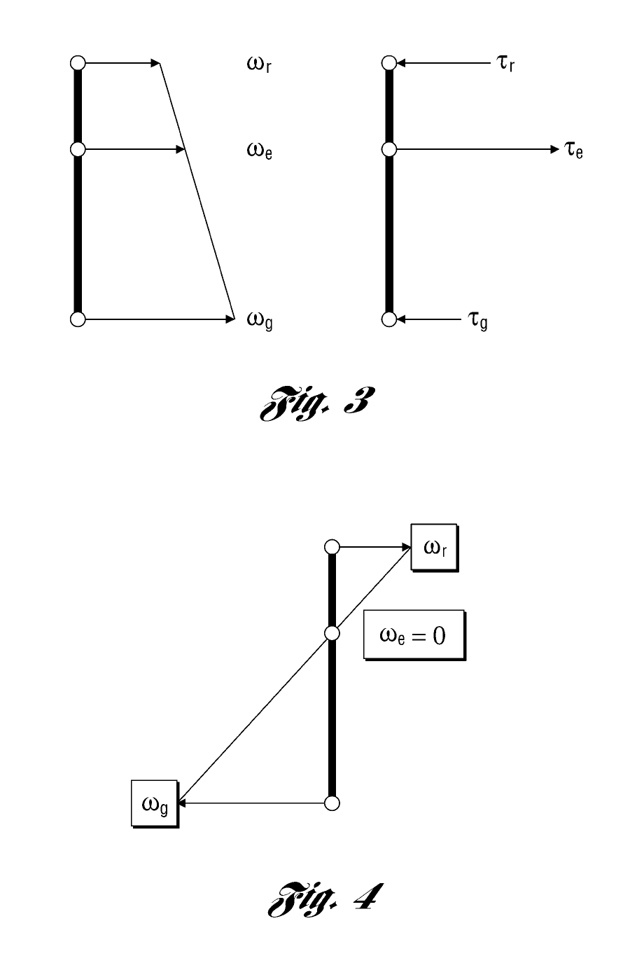

The planetary gear unit 30 includes ring gear 32, sun gear 34 and a planetary carrier 36. Sun gear 34 is connected drivably to the rotor 38 of generator 40. As illustrated in more detail in FIG. 2, the planetary gear unit 30 may include a plurality of planetary gears 35 which are mounted to the planetary carrier 36. The planetary gears 35, which are mounted to the planetary carrier 36, have a speed ω_{c} and a torque τ_{c}, as illustrated in FIG. 2. Likewise, the sun gear 34 has a speed a speed ωₛ and a torque τₛ and the ring gear 32 has a speed ωᵣ and a torque τᵣ, also shown in FIG. 2.

Turning back to FIG. 1, a stator 42 for the generator 40 is electrically coupled to a high voltage inverter 44 and a DC/DC high voltage converter 46, the latter in turn being electrically coupled to the battery, as shown. A battery control module, designated BCM, is also illustrated in FIG. 1. A high voltage inverter 48 is coupled to the stator 14 of motor 10.

The engine 26 is connected drivably to shaft 28 through a damper assembly 52. The differential-and-axle assembly 24 is drivably connected to vehicle traction wheels.

The power flow elements are under the control of a transmission control module (TCM), which is under a supervisory control of a vehicle system controller (VSC). The TCM and VSC are part of a control area network (CAN). Input variables for the VSC may include a driver operating range selector (PRNDL) signal, an accelerator pedal position (APP) signal and a brake pedal signal (BPS). When the generator 40 is commanded to assist the engine 26 during a forward drive vehicle launch, it may be controlled to function as a motor, whereby the planetary carrier 36 turns in a vehicle driving direction. When the generator 40 is acting as a generator to charge the battery, the generator 40 acts as a reaction element as electric power is used to complement engine 26 power. When the generator 40 is used to crank the engine 26 when the vehicle is moving, the generator 40 is controlled to function as a generator, which causes the torque delivered to the sun gear 34 to slow down the sun gear. This results in an increase in planetary carrier 36 speed and engine 26 speed as ring gear 32 speed increases. The electric motor 10 also provides torque to drive the ring gear 32 at this time. Some of the electric power then is used to crank the engine 26. If the ring gear 32 speed is high enough, the planetary carrier 36 speed reaches an engine 26 ignition speed before the generator 40 speed slows down to zero. If the vehicle speed is low, it is possible that the engine 26 speed will not reach the ignition speed even when the generator 40 speed has decreased to zero. In this case, the generator 40 is controlled to function as a motor.

When the transmission architecture of FIG. 1 is used in a so-called “plug-in” hybrid vehicle, the electric motor 10 is used for a considerable percentage of the total operating time for any given driving event with the engine off. At this time, a direct mechanical connection exists between the electric motor 10 and the generator 40. The generator 40 speed thus becomes high when the vehicle speed is at moderate or high levels.

When the engine 26 speed equals zero during all-electric drive, the generator 40 will move at a speed that is a multiple of the motor 10 speed, depending upon the overall gear ratio of the planetary gear unit 30. This may create a problem related to durability of the bearings for the planetary gear unit 30 as well as the generator 40. This problem may limit the road speed of the vehicle to a value that is less than optimum. This also may reduce available torque needed to start the engine when the battery state-of-charge falls below a predetermined threshold during a given driving event before an opportunity exists for recharging the battery using the utility power grid. A need thus exists for a powertrain architecture that would be designed to avoid over-speeding of the generator during operation in an all-electric drive mode.

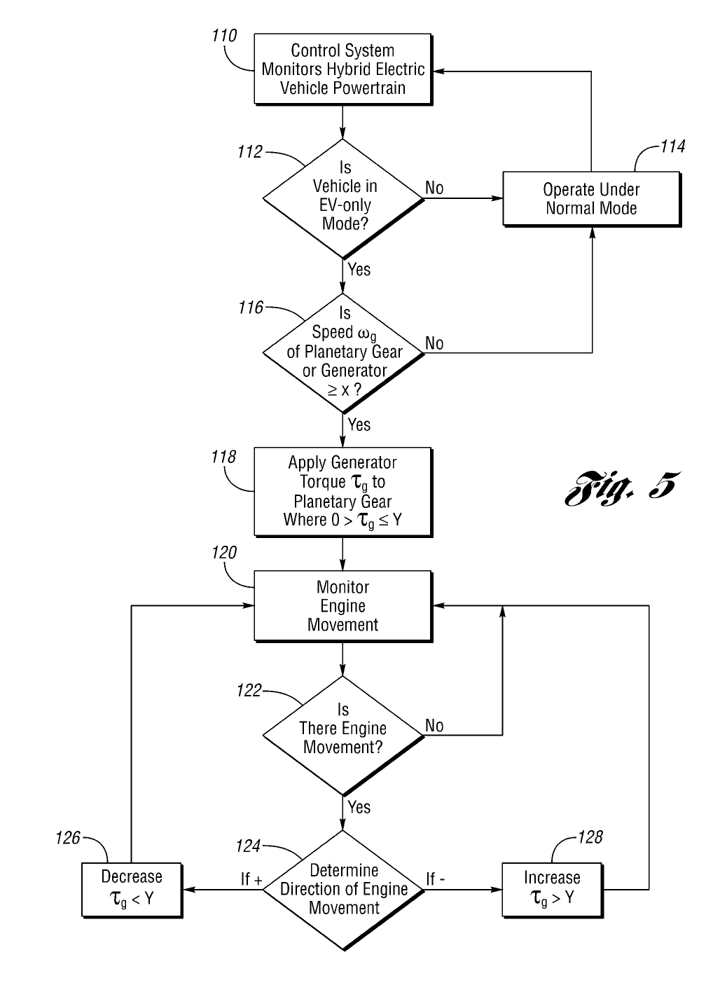

The engine on and off conditions are illustrated by the lever analogy diagrams shown in FIGS. 3 and 4, respectively. FIG. 3 shows speed and torque vectors that exist during motor 10 drive with the engine 26 on for the powertrain illustrated in FIG. 1. In FIG. 3, ωᵣ is the ring gear 32 speed, the ring gear 32 being connected to the traction motor 10 through gears 60, 18 and 20. The symbol ωₑ is the engine 26 speed, the engine 26 being connected to the planetary gear carrier 36. The symbol ω_{g} is the generator 40 speed, the generator 40 being connected to the sun gear 34 so that the generator 40 speed ω_{g} is generally equal to the sun gear 34 speed ωₛ. The symbol τᵣ in FIG. 3 represents ring gear 32 torque. The symbol τₑ represents the engine 26 torque which is generally equal to the planetary carrier 36 torque τ_{c}. Likewise, the symbol τ_{g} represents generator 40 torque, which is generally equal to the sun gear 34 torque τₛ during operation with the engine on.

If the engine 26 is off and the powertrain is powered solely by the motor 10 in an electric-only drive mode, as in the case of a plug-in hybrid powertrain, a public electric utility grid is used to charge the battery, and the battery is designed to have a significantly increased capacity. This makes possible much greater use of the electric-only drive mode.

The direct geared connection of the generator 40 to the wheels, which is indicated in FIG. 1, causes the generator 40 to turn as the vehicle moves with the engine 26 off. Upon an increase in vehicle speed, the generator 40 speed ω_{g} may become excessively high and the torque available to start the engine 26 is lowered. This condition is illustrated in FIG. 4 where ω_{g} is the generator speed. The ring gear 32 is driven in the opposite direction when the engine 26 is off from the direction indicated in FIG. 3 when the engine is on. The engine speed, ωₑ , of course, is zero when the engine is off, as indicated in FIG. 4. The ring gear 32 speed at this time is ωᵣ, which is equal in value to the value for ring gear 32 speed ωᵣ in FIG. 3. When the vehicle is electric-only operation mode the engine 26 and generator 40 provide a drag torque that counter-acts the back-driving torque coming through the ring gear 32. Since the drag torque from the engine 26 and generator 40 passing through the planetary gear unit 30 represents only parasitic losses, the torque passing through the gear unit 30 from the engine 26 and generator 40 is small resulting in minimal load to the planetary bearings in the planetary gear unit 30.

Therefore, in the plug-in hybrid vehicles, the planetary gear unit 30 is running unloaded at high speeds when the vehicle is being driven in electric-only operation mode. Consequently, the higher the speed of the vehicle in electric-only operation mode, the higher the planetary gear unit 30 speed, and consequently, the higher the generator 40 speed. Hence, the planetary gear unit 30 is running unloaded at high speeds when the vehicle is being driven in electric-only operation mode which can cause degradation of the planetary gear unit 30 pinion bearings which are operating at low loads with a tendency to skid and wear. Consequently, this may also limit the speed at which a vehicle may drive in electric-only operation mode and may cause greater hydrocarbon emissions when the engine 26 is required to turn on.

In order to provide a small amount of biasing load to the planetary pinion bearings in the planetary gear unit 30, the generator 40 may apply an amount of torque to the planetary gear unit 30. By applying torque to the planetary gear unit 30, a load is placed on the bearings of the planetary gear unit 30. The amount of torque applied by the generator 40 may be a small amount of torque that is less than or equal to the torque that, when applied to the engine 26, does not result in spinning the engine 26. In one embodiment, the torque applied to the planetary gear unit 30 by the generator 40 is generally equal to the friction torque in the engine 26. In another embodiment, the torque applied by the generator 40 to the planetary gear unit 30 is not greater than the amount of torque required to spin the engine 26. The engine 26 friction torque for a typical warm engine is approximately 10 Newton-meters (Nm) at the engine 26 and approximately 3 Nm at the generator 40. For a cold engine 26, the engine 26 friction torque may be approximately 30 Nm at normal temperatures. Therefore, the engine 26 friction torque, and the generator torque 40 may vary depending on temperature or engine architecture, as well as other factors.

A control system may command the generator 40 to only apply torque to the planetary gear unit 30 when the vehicle is in electric-only operation mode. In an alternate embodiment, the generator 40 only applies torque to the planetary gear unit 30 when the planetary gear unit 30 reaches a threshold speed during electric-only operation mode. The control system for applying torque to the planetary gear unit 30 may be controlled by a closed loop controller 70. The closed loop controller 70 may be part of the vehicle system control (VSC) module, as shown in FIG. 1. Alternatively, the closed loop controller may be part of the transmission control module (TCM) or other vehicle control module. In another embodiment, the controller 70 may be any other stand-alone controller.

FIG. 5 illustrates a flow chart of a control system for the hybrid electric vehicle powertrain. As those of ordinary skill in the art will understand, the functions represented by the flowchart blocks may be performed by software and/or hardware. Also, the functions may be performed in an order or sequence other than that illustrated in FIG. 5. Similarly, one or more of the steps or functions may be repeatedly performed although not explicitly illustrated. Likewise, one or more of the representative steps of functions illustrated may be omitted in some applications. In one embodiment, the functions illustrated are primarily implemented by software instructions, code, or control logic stored in a computer-readable storage medium and if executed by a microprocessor based computer or controller such as the controller 70.

As illustrated in FIG. 5, a control system monitors the hybrid electric vehicle powertrain in step 110. In a second step 112, the controller determines if the vehicle is in electric-only operation mode. If the vehicle is not in electric-only operation mode, the vehicle continues to operate under normal mode 114. If the vehicle is in electric-only operation mode, the control system then determines if the speed of the planetary gear or generator is greater than a predetermined amount X in step 116. If the planetary gear speed or generator speed is less than the predetermined amount X, the vehicle continues to operate under normal mode 114. However, if the speed of the planetary gear or generator is greater than the predetermined amount X, then the control system commands the generator to apply torque to the planetary gear in step 118. The generator applies torque such that the reaction torque to the input shaft of the engine is less than or equal to a predetermined amount Y.

In the next step 120, the control system monitors the engine movement. As shown in FIG. 1, the engine movement may be monitored by a device 80. In one embodiment, the engine movement is monitored by monitoring the engine 26 speed. By monitoring the engine speed, a closed loop control system is essentially monitoring whether or not there is movement of the engine 26 as a result of the torque applied to the planetary gear unit 30 by the generator 40. In another embodiment, engine 26 motion is measured by detecting displacement of the engine 26. The device 80 may be any acceptable method of measuring motion of the engine 26 such as a crank position sensor. In another embodiment, the motion of the engine 26 may be detected by an engine tachometer output pulse or any other engine sensor adapted for detecting engine speed and/or displacement.

If any engine movement is detected in step 122, the control system then determines the direction of engine movement in step 124. If the speed or displacement of the engine is in the positive direction, the amount of torque applied by the generator is decreased so that the torque by the generator applied to the planetary gear unit is less than the predetermined value Y in step 126. If the speed or displacement of the engine is in the reverse direction, the torque applied by the generator to the planetary gear set may be increased so that the torque is greater than the predetermined value Y in step 128.

The amount of torque applied by the generator may be a constant torque value or the torque may be a pre-described random pattern with a nominal torque value equal to a predetermined amount. In the situation where the engine movement is in the reverse direction, the increase of torque by the generator may only increase the nominal torque applied in the pre-described random pattern in step 128. By increasing or decreasing the amount of torque applied by the generator, the movement of the engine is minimized so that the engine speed and the displacement of the engine is generally equal to zero so that emissions and vehicle drivability are not adversely affected.

As illustrated in the FIG. 5, the generator 40 may only apply torque to the planetary gear unit 30 when the planetary gear unit 30 reaches a threshold speed during electric-only operation mode. In another embodiment, it is also contemplated that the control system may apply torque to the planetary gear unit 30 whenever the vehicle is in electric-only operation mode.

The control system may also be employed to maintain a desired traction wheel torque. In one embodiment, the generator 40 is connected to the sun gear 34 and the electric motor 10 is connected to the ring gear 32. Therefore, a reaction torque is applied to the motor 10 as a result of the torque applied to the sun gear 34 by the generator 40. The control system may determine a required motor 10 torque to apply to the traction wheels in order to maintain the desired traction wheel torque in response to the reaction torque applied to the motor 10 by the generator 40 through the planetary gear unit 30. The traction motor 10 torque should be applied to cancel out any reaction effects on the wheel torque as a result of the generator torque applied to the planetary gear unit 30. The control system may employ an algorithm to determine the reaction torque to the motor 10 based on the toque applied by the generator 40 to the planetary gear unit 30 as well as other static and dynamic operating factors.

While various embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method of controlling a hybrid electric vehicle powertrain including an engine, a battery, an electric motor, an electric generator and a transmission with a planetary gear unit, the planetary gear unit mechanically coupling the engine, the electric motor and the electric generator to effect power delivery to vehicle traction wheels, the method comprising:
delivering stored electrical power to the electric motor to drive the traction wheels in an electric-only operation mode; and
applying a first amount of torque to the planetary gear unit with the electric generator in order to reduce wear of the planetary gear unit in the electric-only operation mode.

2. The method of claim 1 further comprising the steps of:
determining a first reaction torque applied to the electric motor as a result of the first amount of electric generator toque applied to the planetary gear unit;
determining a desired traction wheel torque; and
determining a motor torque to apply to the traction wheels in order to maintain the desired traction wheel torque in response to the first reaction amount of torque applied to the motor.

3. The method of claim 1 wherein the first amount of torque is not greater than the amount of torque required to spin the engine.

4. The method of claim 1 wherein the first amount of torque not greater than the frictional forces in the engine.

5. The method of claim 1 wherein the first amount of torque is applied to a first element of the planetary gear unit connected drivably to the generator.

6. The method of claim 5 wherein the first element of the planetary gear unit is a planetary sun gear connected drivably to the generator.

7. The method of claim 2 wherein first reaction amount of torque is the amount of torque applied to a second element of the planetary gear unit connected drivably to the motor as a result of applying torque to the planetary gear unit.

8. The method of claim 7 wherein the second element of the planetary gear unit is a planetary ring gear connected drivably to the motor.

9. The method of claim 1 further comprising the steps of:
measuring the engine speed; and
if the engine speed is greater than a threshold value, decreasing the torque applied to the planetary gear unit by the generator to a second amount of torque, whereby the second amount of torque is less than the first amount of torque.

10. The method of claim 9 wherein the engine speed is measured with a crank position sensor.

11. The method of claim 9 wherein the threshold value is zero, wherein the first amount of torque is decreased to the second amount of torque if there is any rotation of the engine as a result of the first amount of torque applied to the planetary gear unit.

12. A control system for a vehicle having a hybrid powertrain, comprising:
first and second parallel power delivery paths from respective first and second power sources through gearing elements to traction wheels of vehicle; and
a controller configured to command a generator to apply torque to the gearing elements when power is being delivered to the traction wheels through the first power delivery path.

13. The control system of claim 12 further comprising:
a device in communication with the controller for measuring the speed of the second power source,
wherein if the second power source speed is greater than a threshold value, the controller decreases the torque applied to the gearing elements by the generator to a second amount of torque, wherein the second amount of torque is less than the first amount of torque.

14. The control system of claim 12 wherein the controller is further configured to:
determine a first reaction torque applied to the first power source as a result of the first amount of electric generator torque applied to the gearing elements;
determine a desired traction wheel torque; and
determine a motor torque to apply to the traction wheels in order to maintain the desired fraction wheel torque in response to the first reaction amount of torque being applied to the motor.

15. A hybrid electric vehicle powertrain including an engine, an electric motor, an electric generator and a transmission with gearing elements, including a planetary gear unit, mechanically coupling the engine, the electric motor and the electric generator to effect power delivery to vehicle traction wheels;
a first element of the planetary gear unit being connected drivably to the generator;
a second element of the planetary gear unit being connected drivably to the motor;
a third element of the planetary gear unit being connected drivably to the engine; and
a controller configured to command the generator to apply torque to the first planetary gear element when the vehicle is in an electric-only operation mode whereby wear of the planetary gear unit is reduced.

16. The hybrid electric vehicle powertrain set forth in claim 15 wherein the first element of the planetary gear unit is a planetary sun gear connected drivably to the generator.

17. The hybrid electric vehicle powertrain set forth in claim 15 wherein the second element of the planetary gear unit is a planetary ring gear connected drivably to the motor.

18. The hybrid electric vehicle powertrain set forth in claim 15 wherein the third element of the planetary gear unit is a planetary carrier connected drivably to the engine.

19. The hybrid electric vehicle powertrain set forth in claim 15 further comprising:
a device in communication with the controller for measuring engine speed,
wherein if the engine speed is greater than a threshold value, the controller decreases the torque applied to the gearing elements by the generator to a second amount of torque, whereby the second amount of torque is less than the first amount of torque.

20. The hybrid electric vehicle powertrain set forth in claim 19 wherein the device is a crank position sensor.
